(19) United States
(12) Patent Application Publication
(10) Pub. No.: US 2011/0131334 A1
(43) Pub. Date: Jun. 2, 2011

(54) ELECTRONIC APPARATUS AND COMMUNICATION CONTROL METHOD

(75) Inventor: Nobuaki Takasu, Akishima-shi (JP)

(73) Assignee: KABUSHIKI KAISHA TOSHIBA, Tokyo (JP)

(21) Appl. No.: 12/956,759

(22) Filed: Nov. 30, 2010

(30) Foreign Application Priority Data
Nov. 30, 2009 (JP) 2009-272692

(51) Int. Cl. G06F 15/16; H04B 7/00

(52) U.S. Cl. 709/227; 455/41.2

(57) ABSTRACT

According to one embodiment, an electronic apparatus includes a communication module, a connection request transmitter, a connection response receiver, a response time measuring module, a stability determination module, and a connection controller. The communication module executes close proximity wireless communication. The connection request transmitter transmits a connection request signal to an external device. The connection response receiver receives from the external device a connection response signal responding to the connection request signal. The response time measuring module measures a response time indicative of an elapsed time from the transmission of the connection request signal to the reception of the connection response signal. The stability determination module determines whether communication between the communication module and the external device is in a stable state based on the response time. The connection controller establishes connection between the communication module and the external device when the communication is in the stable state.

### CROSS-REFERENCE TO RELATED APPLICATIONS

This application is based upon and claims the benefit of priority from Japanese Patent Application No. 2009-272692, filed Nov. 30, 2009; the entire contents of which are incorporated herein by reference.

### FIELD

Embodiments described herein relate generally to an electronic apparatus which executes close proximity wireless communication, and a communication control method applied to the electronic apparatus.

### BACKGROUND

In recent years, wireless communication such as near field communication (NFC) has begun to be used. A user can easily execute communication for an authentication process, an accounting process, etc., simply by performing such an operation as holding an IC card over a reader/writer module of a host apparatus. In addition, recently, a novel close proximity wireless communication technology, which enables high-speed data exchange between devices, has begun to be developed.

In order to smoothly execute such communication, it is desirable to provide a stable communication path.

Jpn. Pat. Appln. KOKAI Publication No. 2006-324945 discloses a communication terminal device which selects, from communication paths, a communication path which meets a predetermined condition. The communication terminal device selects a communication path, based on the communication quality of each of the communication paths.

In the meantime, in the close proximity wireless communication, a communication path is set between devices. In this communication path, by keeping the devices in close proximity state, stable close proximity wireless communication can be executed. However, if the connection between the devices is established and communication is executed while the positional relationship between the devices is varying, for example, during an operation of bringing the devices close to each other, stable communication may not be executed. For example, it is possible that time required for data transfer increases by re-transmitting a packet due to an error at a time of communication. In addition, for example, it is possible that the data transmission is suspended by being released the connection between the devices. However, it is difficult to determine, from appearance, whether the devices, which are positioned close to each other, are in such a close proximity state that stable communication can be executed.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view showing the external appearance of an electronic apparatus according to an embodiment.

FIG. 2 is an exemplary block diagram showing the structure of the electronic apparatus of the embodiment.

FIG. 3 shows an example of close proximity wireless communication executed between the electronic apparatus of the embodiment and an external device.

FIG. 4 shows an example of software architecture for controlling close proximity wireless communication, which is applied to the electronic apparatus of the embodiment.

FIG. 5 is an exemplary block diagram showing the functional structure of a communication control program which is executed in the electronic apparatus of the embodiment.

FIG. 6 is an exemplary view for explaining an example of measurement of a connection response time in a connection sequence between a close proximity wireless communication module in the electronic apparatus of the embodiment and an external device.

FIG. 7 is an exemplary view for explaining another example of the measurement of the connection response time in the connection sequence between the close proximity wireless communication module in the electronic apparatus of the embodiment and the external device.

FIG. 8 shows an exemplary relationship between the connection response time and a throughput in the connection sequence by close proximity wireless communication between devices.

FIGS. 9A and 9B show examples of a display which indicate the stability of close proximity wireless communication between the close proximity wireless communication module in the electronic apparatus of the embodiment and the external device.

FIG. 10 shows an example of a connection sequence by close proximity wireless communication between the close proximity wireless communication module in the electronic apparatus of the embodiment and the external device.

FIG. 11 shows another example of the connection sequence by close proximity wireless communication between the close proximity wireless communication module in the electronic apparatus of the embodiment and the external device.

FIG. 12 shows still another example of the connection sequence by close proximity wireless communication between the close proximity wireless communication module in the electronic apparatus of the embodiment and the external device.

FIG. 13 is an exemplary flowchart illustrating an example of the procedure of a connection control process executed by the electronic apparatus of the embodiment.

FIG. 14 is an exemplary flowchart illustrating another example of the procedure of the connection control process executed by the electronic apparatus of the embodiment.

### DETAILED DESCRIPTION

Various embodiments will be described hereinafter with reference to the accompanying drawings.

In general, according to one embodiment, an electronic apparatus includes a communication module, a connection request transmitter, a connection response receiver, a response time measuring module, a stability determination module, and a connection controller. The communication module executes close proximity wireless communication. The connection request transmitter transmits a connection request signal to an external device close to the communication module. The connection response receiver receives from the external device a connection response signal responding to the connection request signal. The response time measuring module measures a response time indicative of an elapsed time from the transmission of the connection request signal to the reception of the connection response signal. The stability determination module determines whether communication between the communication module and the external device is in a stable state based on the response time. The connection controller establishes connection between the communication module and the external device when the stability determination module determines that the communication is in the stable state.

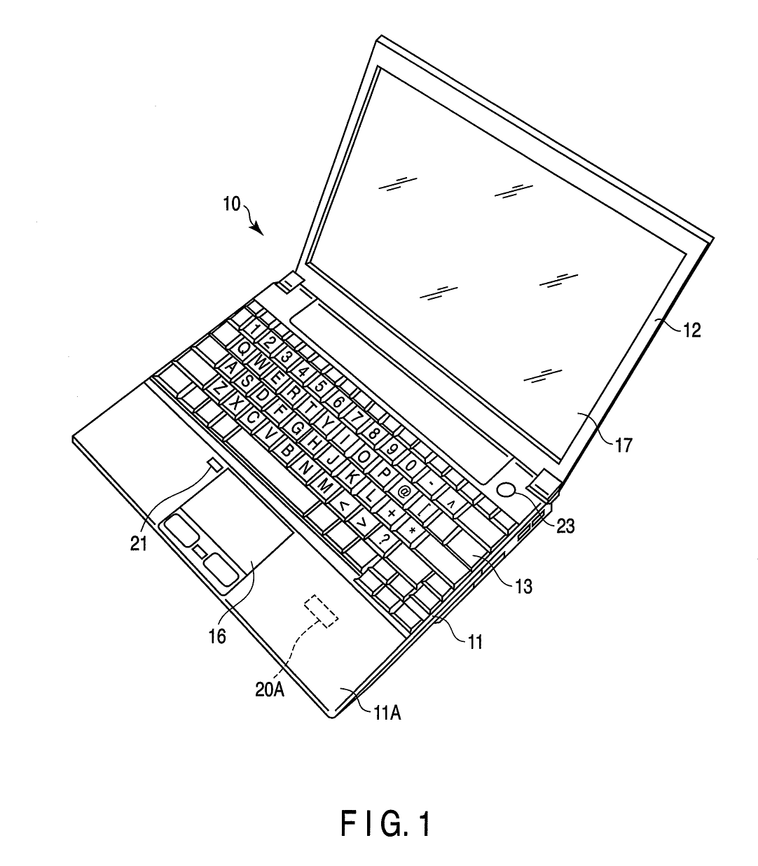

FIG. 1 is a view showing the external appearance of an electronic apparatus according to an embodiment. The electronic apparatus 10 is realized, for example, as a portable personal computer.

The electronic apparatus 10 includes a main body 11 and a display unit 12. The display unit 12 is attached to the main body 11 such that the display unit 12 is rotatable between an open position where the top surface of the main body 11 is exposed, and a closed position where the top surface of the main body 11 is covered by the display unit 12. An LCD 17 is provided in the display unit 12.

The main body 11 has a thin box-shaped housing. A keyboard 13, a touch pad 16, an indicator 21, and a power switch 23 are disposed on the top surface of the housing of the main body 11.

The top surface of the main body 11, to be more specific, a part of a palm rest area 11A on the top surface of the main body 11, functions as a communication surface. Specifically, a close proximity wireless communication module 20 and an antenna (coupler) 20A are provided within the main body 11 such that the close proximity wireless communication module 20 and antenna (coupler) 20A are opposed to the palm rest area 11A on the top surface of the main body 11. The antenna (coupler) 20A is disposed in such a manner as to output a wireless signal (induction electric field) to the outside via the top surface of the main body 11 (specifically, a part of the palm rest area 11A on the top surface of the main body 11). A small area on the top surface of the main body 11, which is opposed to the antenna (coupler) 20A, that is, a small area on the top surface of the main body 11, which is positioned above the antenna (coupler 20A), is used as a communication position.

The user can start data transfer between an external device and the electronic apparatus 10 by performing, for example, an operation (“touch operation”) of bringing the external device, which has a close proximity wireless communication function, over the communication position on the palm rest area 11A of the main body 41.

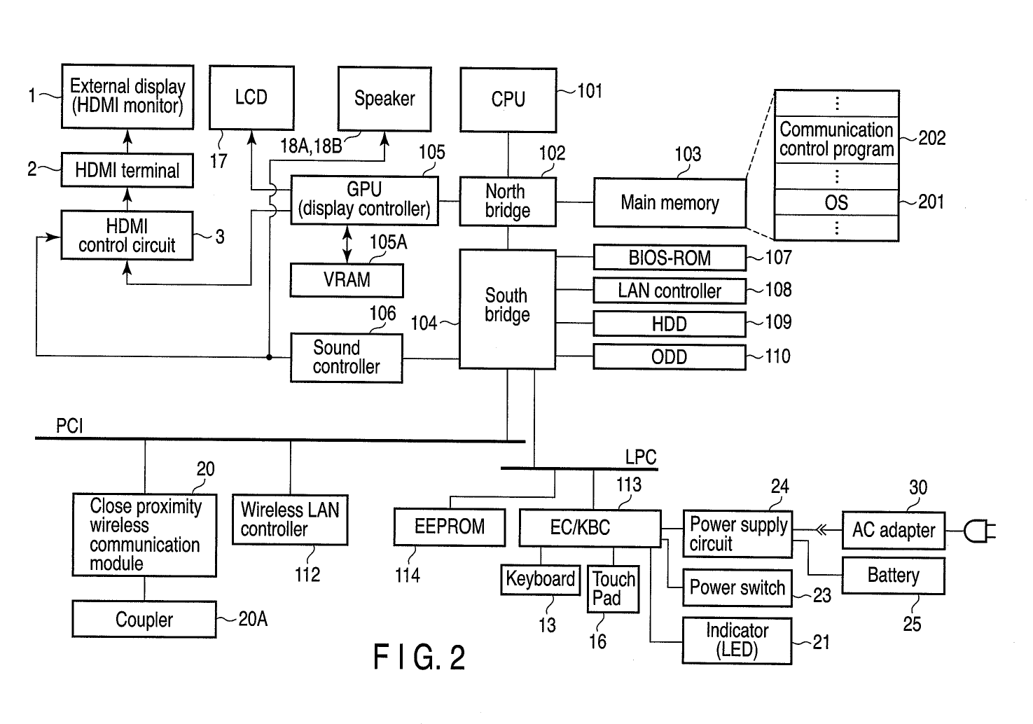

FIG. 2 shows the system configuration of the electronic apparatus 10.

The electronic apparatus 10, as shown in FIG. 2, includes a CPU 101, a north bridge 102, a main memory 103, a south bridge 104, a GPU 105, a VRAM 105A, a sound controller 106, a BIOS-ROM 107, a LAN controller 108, a hard disk drive (HDD) 109, an optical disc drive (ODD) 110, a wireless LAN controller 112, an embedded controller/keyboard controller (EC/KBC) 113, an EEPROM 114, and a close proximity wireless communication module 20.

The CPU 101 is a processor which controls the operation of the electronic apparatus 10. The CPU 101 executes an operating system (OS) 201 and various application programs, such as a communication control program 202, which are loaded from the HDD 109 into the main memory 103. The communication control program 202 is software having a function of controlling close proximity wireless communication between the close proximity wireless communication module 20 and an external device. In addition, the CPU 101 executes a BIOS stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of executing communication with the GPU 105 via, e.g. a PCI EXPRESS serial bus.

The GPU 105 is a display controller which controls the LCD 17 used as a display monitor of the electronic apparatus 10. A display signal, which is generated by the GPU 105, is sent to the LCD 17. In addition, the GPU 105 can send a digital video signal to an external display device 1 via an HDMI control circuit 3 and an HDMI terminal 2.

The HDMI terminal 2 is an external display connection terminal. The HDMI control circuit 3 is an interface for sending a digital video signal to the external display device 1, which is called “HDMI monitor”, via the HDMI terminal 2.

The south bridge 104 controls devices on a peripheral component interconnect (PCI) bus and devices on a low pin count (LPC) bus. The south bridge 104 includes an integrated drive electronics (IDE) controller for controlling the HDD 109 and ODD 110. The south bridge 104 also has a function of executing communication with the sound controller 106.

The sound controller 106 is a sound source device and outputs audio data of a target to the speakers 18A and 18B or the HDMI control circuit 3.

The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11g standard.

The EC/KBC 113 is a One-chip microcomputer in which an embedded controller for power management and a keyboard controller for controlling the keyboard 13 and touch pad 16 are integrated. The indicator 21, which is connected to the EC/KBC 113, indicates the state of close proximity wireless communication (the start of data transfer, the end of data transfer, the stability of communication, etc.) executed by the close proximity wireless communication module 20. The indicator 21 includes a light emission module such as an LED.

A power supply circuit 24, which is connected to the EC/KBC 113, supplies power to the respective components in the computer 10, by using power supplied from the outside via an AC adapter 30 or power supplied from a battery 25 in the electronic apparatus 10. In other words, the electronic apparatus 10 is driven by an external power supply such as an AC commercial power supply, or by the battery 25. The AC adapter 30 may be provided within the electronic apparatus 10. The EC/KBC 113 powers on/off the electronic apparatus 10 in accordance with the user's operation of the power switch 23.

The close proximity wireless communication module 20 is a communication module which executes close proximity wireless communication. The close proximity wireless communication module 20 is capable of communicating with some other device (external device) having a close proximity wireless communication function, which is present within a predetermined distance from the close proximity wireless communication module 20. The wireless transfer between the close proximity wireless communication module 20 and the external device is enabled only if the close proximity wireless communication module 20 and the external device are in a close proximity state, that is, only if the distance between the close proximity wireless communication module 20 and the external device is within the range of communication (e.g. 3 cm). When the close proximity wireless communication module 20 and the external device are brought close to each other within the range of communication, the communication between the close proximity wireless communication module 20 and the external device is enabled. Then, the operation of establishing connection (wireless connection) between the close proximity wireless communication module 20 and the external device is started. After the connection (wireless connection) between the devices is established, transfer of data, such as a data file designated by the user, or a predetermined data file to be synchronized, is executed between the close proximity wireless communication module 20 and the external device.

In the close proximity wireless communication, an induction electric field is used. As a close proximity wireless communication method, TransferJET, for instance, can be used. TransferJET is a close proximity wireless communication method which uses UWB, and high-speed data transfer can be realized.

The close proximity wireless communication module 20 is connected to the antenna 20A. The antenna 20A is an electrode called “coupler”, and executes data transmission/reception to/from the external device by a wireless signal using an induction electric field. When the external device comes near within the range of communication (e.g. 3 cm) from the antenna 20A, the antennas (couplers) of the close proximity wireless communication module 20 and the external device are coupled by the induction electric field, and thereby wireless communication between the close proximity wireless communication module 20 and the external device is enabled. In the meantime, the close proximity wireless communication module 20 and the antenna 20A can be realized as a single module.

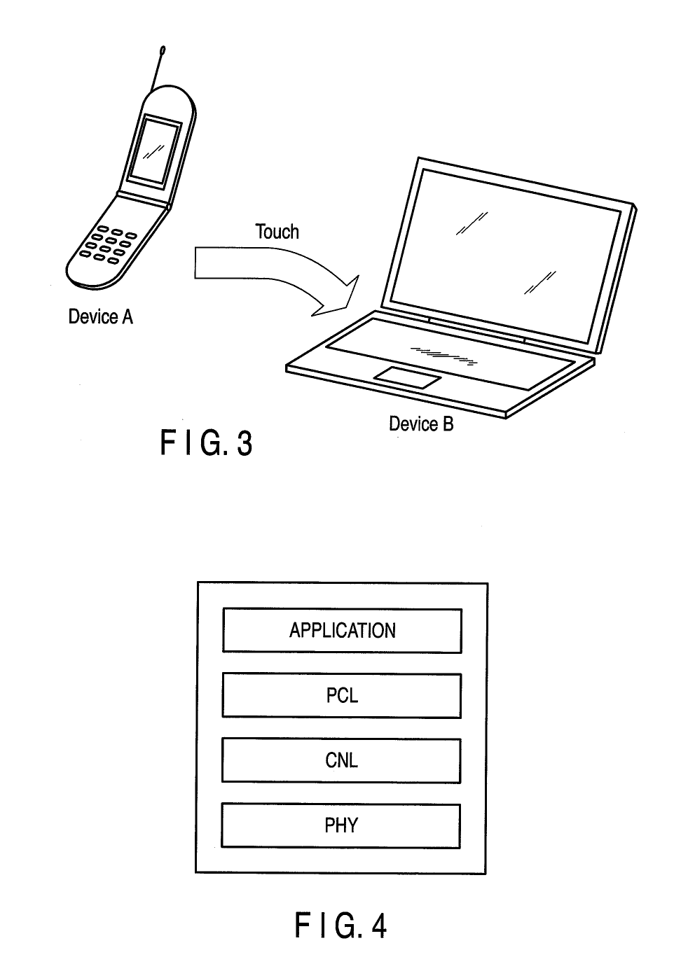

FIG. 3 illustrates close proximity wireless communication executed between a mobile phone and the electronic apparatus 10. An antenna (coupler) for close proximity wireless communication is provided within the housing of the mobile phone so as to be opposed to the back surface of the housing. In this case, close proximity wireless communication between the mobile phone and electronic apparatus 10 can be started by bringing the back surface of the housing of the mobile phone over the communication position on the palm rest area 11A of the main body 11 of the electronic apparatus 10.

Next, referring to FIG. 4, a description is given of a software architecture for controlling close proximity wireless communication executed with use of the close proximity wireless communication module 20.

The software architecture of FIG. 4 shows a hierarchical structure of a protocol stack for controlling close proximity wireless communication. The protocol stack includes a physical layer (PHY), a connection layer (CNL), a protocol conversion layer (PCL), and an application layer.

The physical layer (PHY) is a layer which controls physical data transfer, and corresponds to a physical layer in an OSI reference model. A part or all of the functions of the physical layer (PHY) may also be realized by using hardware in the close proximity wireless communication module 20.

The physical layer (PHY) converts data from the connection layer (CNL) to a wireless signal. The connection layer (CNL) corresponds to a data link layer, a network layer and a transport layer in the OSI reference model, and executes data transfer by controlling the physical layer (PHY).

Responding to a connection request from the protocol conversion layer (PCL) or a connection request from the external device, the connection layer (CNL) executes a process of establishing (physical) connection between the close proximity wireless communication module 20 and the external device, which are positioned in a close proximity state. A description is now given of the procedure for establishing connection between two devices (device 1 and device 2). Of the devices 1 and 2, the device which is to start communication, for example, the device 1, executes a process for wirelessly transmitting a connection request (C-Req). The connection request (C-Req) may include a unique ID of the device 1. The device 2 periodically executes a process for receiving the connection request (C-Req). When the device 1 and device 2 are in a close proximity state, the device 2 can receive the connection request (C-Req) transmitted from the device 1. When the device 2 has received the connection request (C-Req), the device 2 wirelessly transmits a response (C-Ack) which is indicative of the acceptance of the received connection request (C-Req). This response (C-Ack) may include a unique ID of the device 2. The device 1 can receive the response (C-Ack) wirelessly transmitted from the device 2. In this manner, the connection between the device 1 and device 2 is established by transmitting/receiving the connection request signal (C-Req) and connection response signal (C-Ack) between the device 1 and device 2.

The protocol conversion layer (PCL) corresponds to a session layer and a presentation layer in the OSI reference model, and is positioned between the application layer and the connection layer (CNL) for controlling establishment and release of a link between the two devices. In order to establish the connection between the two devices, the protocol conversion layer (PCL) executes control of each application (communication program) in the application layer, and executes control of the connection layer (CNL).

To be more specific, the protocol conversion layer (PCL) executes a conversion process for converting data (user data), which corresponds to application protocols (e.g. SCSI, OBEX, and other general-purpose protocols) that are handled by the communication programs in the application layer, to a specific transmission data format. By this conversion process, data, which is transmitted/received by any one of the communication programs, is converted to a packet (data of a specific transmission data format) which can be handled by the connection layer (CNL).

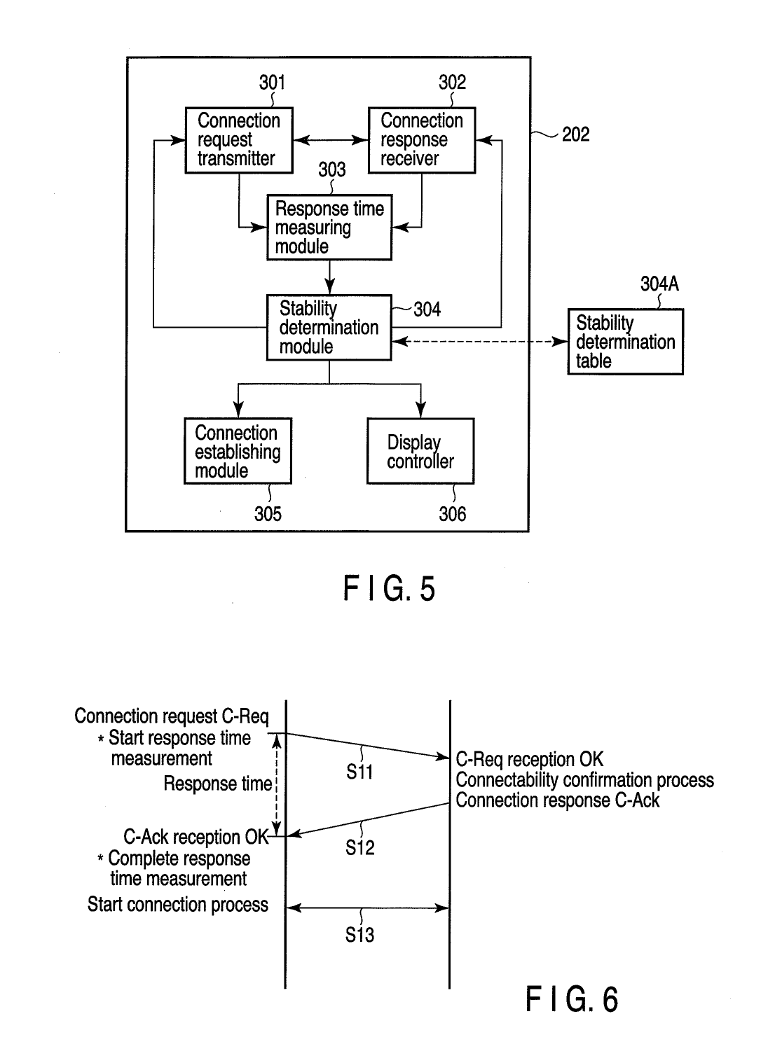

Next, referring to FIG. 5, a description is given of a functional structure of the communication control program 202 which runs on the electronic apparatus 10. A structure example, which is described here, is for realizing, among the functions of the communication control program 202, a function for controlling the connection established between the close proximity wireless communication module 20 and the external device having the close proximity wireless communication function.

In wireless communication, the intensity of radio waves which are received may be used as an index for determining the stability of communication and the speed of communication. The device, which executes wireless communication, measures the intensity of radio waves, and displays the magnitude of radio waves with use of numerical values, a graph, etc. However, in the close proximity wireless communication, since the transmission output of radio waves is small, a difference hardly occurs in received radio wave intensity even if the communication state varies. Thus, in the close proximity wireless communication, it is difficult to use the received radio wave intensity as the index of the stability of communication and the speed of communication.

In addition, the index of the stability of communication and the speed of communication based on the received radio wave intensity is indicative of the reception state of one of the two devices. It is thus difficult to estimate the reception state of the other device by using the index based on the received radio wave intensity. In other words, with use of the received radio wave intensity, the reception state of one of two devices can be determined, but the condition of reach of radio waves from this one device to the other device cannot be determined. It is thus difficult to determine the stability of communication and the speed of communication between the two devices.

In the present embodiment, the response time at the time of connection request is measured by making use of a connection request signal (C-Req) and a connection response signal (C-Ack) which are used when connection is established between the close proximity wireless communication module 20 and external device. The response time is indicative of an elapsed time from when the close proximity wireless communication module 20 transmits a connection request signal to the external device to when the close proximity wireless communication module 20 receives from the external device a connection response signal responding to the connection request signal. Specifically, the measured response time represents a time needed for actual communication (transmission/reception of signals) between the devices. Therefore, by using the index based on the response time, it is possible to determine whether the stability of communication and the speed of communication are high or low, with a higher reliability than the index based on the radio wave intensity.

This being the case, the communication control program 202 has the function of measuring the response time and determining the stability of communication between the devices, based on the measured response time, when connection is established between the close proximity wireless communication module 20 and the external device having the close proximity wireless communication function. The communication control program 202 includes a connection request transmitter 301, a connection response receiver 302, a response time measuring module 303, a stability determination module 304, a connection establishing module 305, and a display controller 306.

The connection request transmitter 301 transmits a connection request signal (C-Req) to the external device. The connection response receiver 302 receives a connection response signal (connection acceptance response signal: C-Ack) transmitted from the external device in response to the connection request signal transmitted from the connection request transmitter 301. If the connection response receiver 302 does not receive a connection response signal sent from the external device even after the passing of a predetermined time since the transmission of the connection request signal to the external device, the connection request transmitter 301 re-transmits a connection request signal to the external device. In this case, the connection response receiver 302 receives a connection response signal which is sent from the external device in response to the connection request signal that has been re-transmitted.

The response time measuring module 303 measures a response time which is indicative of an elapsed time from the transmission of the connection request signal by the connection request transmitter 301 to the reception of the connection response signal by the connection response receiver 302.

Referring to a figure of sequence shown in FIG. 6, a description is given of an example of the response time measured when connection is established between the close proximity wireless communication module 20 and the external device.

To start with, the connection request transmitter 301 transmits a connection request signal (C-Req) to the external device (S11). Responding to the transmission of the connection request signal, the response time measuring module 303 starts measuring the response time.

Responding to the reception of the connection request signal transmitted by the connection request transmitter 301, the external device executes a process of confirming whether the connection to the close proximity wireless communication module 20 is enabled. If the connection to the close proximity wireless communication module 20 is enabled, the external device transmits a connection response signal (C-Ack), which is indicative of the acceptance of the connection request, to the close proximity wireless communication module 20 (S12).

Subsequently, the connection response receiver 302 receives the connection response signal transmitted from the external device. Responding to the reception of the connection response signal, the response time measuring module 303 completes the measurement of the response time. Specifically, the response time measuring module 303 measures, as the response time, the elapsed time from when the connection request signal was transmitted by the connection request transmitter 301 to when the connection response signal has been received by the connection response receiver 302. Based on the measured response time, the stability determination module 304 determines the stability of communication between the close proximity wireless communication module 20 and the external device. The stability of communication between the close proximity wireless communication module 20 and the external device means the stability of the environment of communication between these devices. Even if the close proximity wireless communication module 20 and the external device are positioned in close proximity within the range of communication, the environment of communication between these devices varies depending on, for example, the degree of alignment of the positional relationship between the close proximity wireless communication module 20 and the external device.

When the stability determination module 304 determines that the communication between the devices is stable, the connection establishing module 305 executes a process for establishing the connection by close proximity wireless communication between the close proximity wireless communication module 20 and the external device (S13).

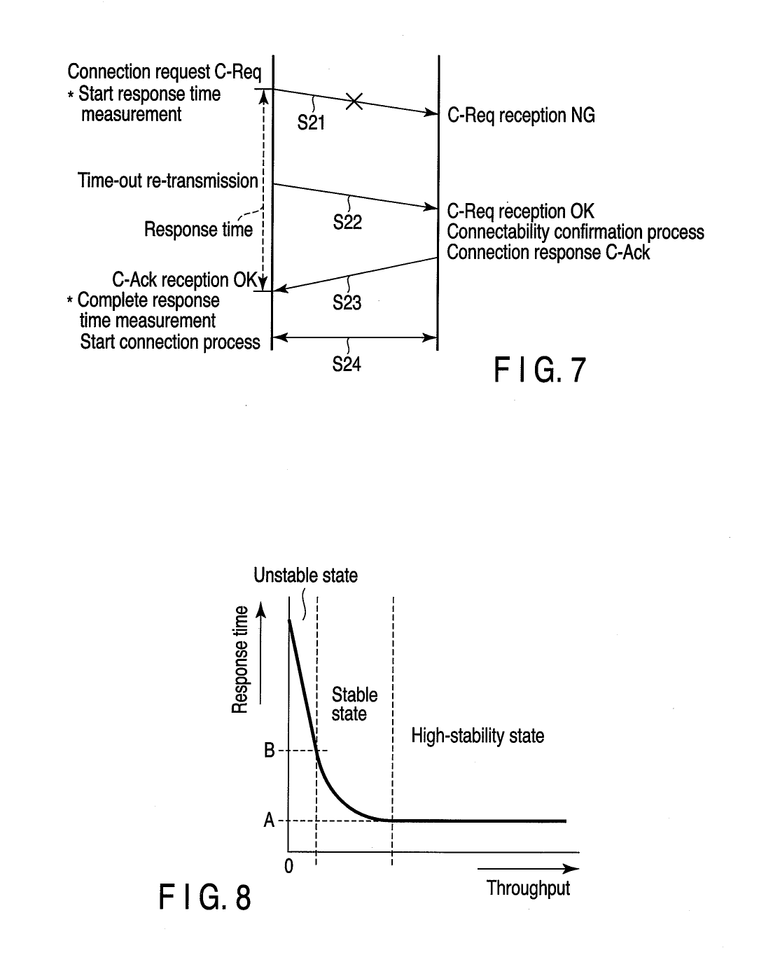

FIG. 7 shows another example of the response time measured when connection is established between the close proximity wireless communication module 20 and the external device.

To start with, the connection request transmitter 301 transmits a connection request signal (C-Req) to the external device (S21). Responding to the transmission of the connection request signal, the response time measuring module 303 starts measuring the response time.

In sequence S21, it is assumed that the connection request signal, which was transmitted by the connection request transmitter 301, failed to be received by the external device (C-Req reception NG). In this case, since the external device does not receive the connection request signal, the external device, as a matter of course, does not transmit a connection response signal (C-Ack) to the close proximity wireless communication module 20.

If the connection response receiver 302 does not receive the connection response signal from the external device even after the passing of a predetermined period (time-out), the connection request transmitter 301 retransmits a connection request signal to the external device (S22).

Responding to the reception of the connection request signal which has been re-transmitted by the connection request transmitter 301, the external device executes a process of confirming whether the connection to the close proximity wireless communication module 20 is enabled. If the connection to the close proximity wireless communication module 20 is enabled, the external device transmits a connection response signal, which is indicative of the acceptance of the connection request, to the close proximity wireless communication module 20 (S23).

Subsequently, the connection response receiver 302 receives the connection response signal transmitted from the external device. Responding to the reception of the connection response signal, the response time measuring module 303 completes the measurement of the response time. Specifically, the response time measuring module 303 measures, as the response time, the elapsed time from when the connection request signal was first transmitted by the connection request transmitter 301 to when the connection response signal has been received by the connection response receiver 302 after the re-transmission of the connection request signal due to the time-out. Based on the measured response time, the stability determination module 304 determines the stability of communication between the close proximity wireless communication module 20 and the external device. When the stability determination module 304 determines that the communication between the devices is stable, the connection establishing module 305 executes a process for establishing the connection by close proximity wireless communication between the close proximity wireless communication module 20 and the external device (S24).

The stability determination module 304 determines, with use of a stability determination table 304A, the stability of close proximity wireless communication between the close proximity wireless communication module 20 and the external device, based on the response time measured by the response time measuring module 303. The stability determination module 304 determines the stability, for example, by using data indicative of the relationship between the response time and a throughput, which is stored in the stability determination table 304A.

FIG. 8 is a graph showing the relationship between the response time and a throughput. As shown in FIG. 8, when the response time is less than a threshold A, the throughput between the close proximity wireless communication module 20 and the external device is high. In other words, this state is a high-stability state in the stability of communication between the close proximity wireless communication module 20 and the external device is high, and the speed of communication is high.

When the response time is the threshold A or more and is less than a threshold B, the throughput between the close proximity wireless communication module 20 and the external device has a value which is a predetermined value or more. In other words, this state of communication between the close proximity wireless communication module 20 and the external device is a stable state in which, although there is a possibility of, e.g. re-transmission due to an error, a predetermined stability (throughput) is ensured.

When the response time is the threshold B or more, the throughput between the close proximity wireless communication module 20 and the external device is low, and it is possible that a minimum throughput, which is required by an application, etc., cannot be satisfied. In other words, this state of communication between the close proximity wireless communication module 20 and the external device is an unstable state in which there is a possibility that re-transmission due to an error repeatedly occurs and the connection itself is released.

Using the stability determination table 304A which describes the above relationship between the response time and throughput, the stability determination module 304 determines the stability based on the present response time in the communication between the close proximity wireless communication module 20 and the external device. Specifically, when the response time is less than the threshold A, the stability determination module 304 determines that the communication between the close proximity wireless communication module 20 and the external device is in the high-stability state. When the response time is not less than the threshold A and is less than the threshold B, the stability determination module 304 determines that the communication between the close proximity wireless communication module 20 and the external device is in the stable state. When the response time is the threshold B or more, the stability determination module 304 determines that the communication between the close proximity wireless communication module 20 and the external device is in the unstable state.

When the communication between the close proximity wireless communication module 20 and the external device is determined to be in the high-stability state or in the stable state, the connection establishing module 305 executes the process for establishing the connection between the close proximity wireless communication module 20 and the external device. On the other hand, when the communication between the close proximity wireless communication module 20 and the external device is determined to be in the unstable state, the connection establishing module 305 does not execute the process for establishing the connection between the close proximity wireless communication module 20 and the external device.

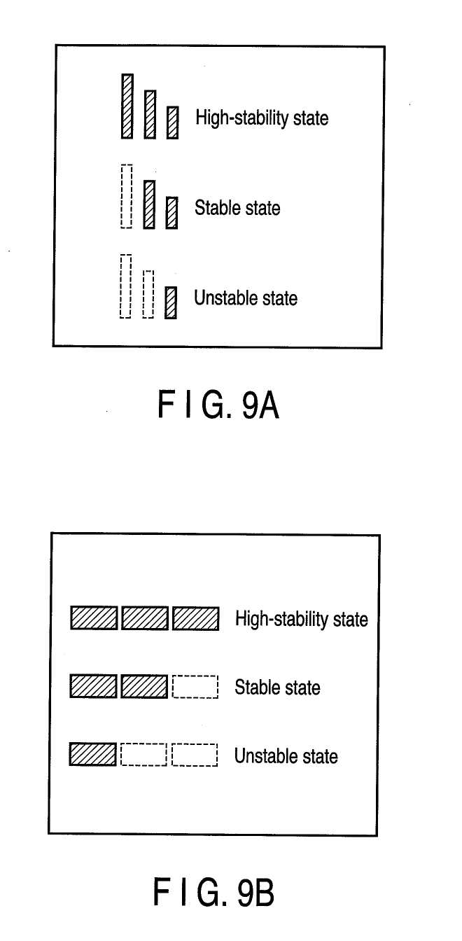

The display controller 306 executes control for displaying on the LCD 17 the index indicating the stability of communication between the close proximity wireless communication module 20 and the external device. FIGS. 9A and 9B show examples of the index indicating the stability of communication, which is displayed by the display controller 306. In FIG. 9A, three vertical bars with different lengths are used, as in the case of the display indicating the radio wave intensity of mobile phones. When three vertical bars are displayed, the high-stability state of communication is indicated. When two vertical bars are displayed, the stable state of communication is indicated, and when one vertical bar is displayed, the unstable state is indicated. In FIG. 9B, three arranged rectangles are used. When three rectangles are displayed, the high-stability state of communication is indicated. When two rectangles are displayed, the stable state of communication is indicated, and when one rectangle is displayed, the unstable state is indicated. In the above-described examples, the index of stability is expressed in three levels. However, the index of stability is not limited to the three levels, and the display controller 306 may display an arbitrary state of stability on the LCD 17, etc. In addition, the display controller 306 may display an estimated speed of communication between the close proximity wireless communication module 20 and the external device. The display controller 306 presents information relating to the stability of communication and the speed of communication by displaying various objects, such as graphs, numerical values and icons, and altering display modes such as colors and sizes of these objects. The display controller 306 may execute control for displaying the index indicating of the stability of communication and the speed of communication, by using lighting (flickering) of the indicator (LED) 21. The display controller 306 may turn on indicators (LED) 21 of various colors in accordance with the stability of communication and the speed of communication. Furthermore, when the communication between the close proximity wireless communication module 20 and the external device is in the unstable state, the display controller 306 causes the LCD 17 to display a message prompting the user to adjust (re-operate) the positional relationship between the devices, for example, a message prompting the user to re-perform a touch operation for bringing the devices close to each other, or a message informing the user that the positional relationship between the devices is not aligned.

The stability determination module 304 may determine the stability of communication between the close proximity wireless communication module 20 and the external device, by using the response times which have been measured N times (N≧2) by the response time measuring module 303. For example, in the case of measuring the response time twice, the response time measuring module 303 performs the following measurement.

At first, the response time measuring module 303 measures a first response time which is indicative of an elapsed time from when a first connection request signal is transmitted to the external device by the connection request transmitter 301, to when a first connection response signal from the external device, which responds to the first connection request signal, is received by the connection response receiver 302. Then, the response time measuring module 303 measures a second response time which is indicative of an elapsed time from when a second connection request signal is transmitted to the external device by the connection request transmitter 301, to when a second connection response signal from the external device, which responds to the second connection request signal, is received by the connection response receiver 302.

Using the first response time and second response time, the stability determination module 304 determines the stability of communication between the close proximity wireless communication module 20 and the external device. Specifically, the stability determination module 304 determines whether the absolute value of the difference between the first response time and the second response time is a first threshold or less. When the absolute value of the difference between the first response time and the second response time is the first threshold or less, it is possible, for example, that the variation in the positional relationship between the close proximity wireless communication module 20 and the external device is small. In other words, since the absolute value of the difference between the first response time and the second response time is the first threshold or less, it is estimated that the close proximity wireless communication module 20 and the external device are kept in a similar close-proximity state at the time of measurement of the first response time and at the time of measurement of the second response time.

When the absolute value of the difference between the first response time and the second response time is the first threshold or less, the stability determination module 304 determines whether the second response time corresponds to the high-stability state, stability state or unstable state, using the stability determination table 304A in which the data indicative of the above-described relationship between the response time and throughput is stored. It is also possible to determine whether the average between the first response time and second response time corresponds to the high-stability state, stability state or unstable state. If it is determined that the communication between the close proximity wireless communication module 20 and the external device is in the high-stability state or in the stable state, that is, if the positional relationship between the close proximity wireless communication module 20 and the external device is sufficiently adjusted, the connection establishing module 305 executes the process for establishing the connection between the close proximity wireless communication module 20 and the external device. If it is determined that the communication between the close proximity wireless communication module 20 and the external device is in the unstable state, that is, if the positional relationship between the close proximity wireless communication module 20 and the external device is not sufficiently adjusted, the connection establishing module 305 does not execute the process for establishing the connection therebetween.

If the absolute value of the difference between the first response time and the second response time is greater than the first threshold, the stability determination module 304 determines that the communication between the close proximity wireless communication module 20 and the external device is in the unstable state. When the absolute value of the difference between the first response time and the second response time is greater than the first threshold, it is possible, for example, that the variation in the positional relationship between the close proximity wireless communication module 20 and the external device is large. To be more specific, it is possible that the user is performing the operation of bringing the external device close to the close proximity wireless communication module 20. Thus, when the absolute value of the difference between the first response time and the second response time is greater than the first threshold, it is highly possible that the close proximity wireless communication module 20 and the external device are not kept in the similar close-proximity state and stable close proximity wireless communication cannot be executed. Hence, the connection establishing module 305 does not execute the process for establishing the connection between the close proximity wireless communication module 20 and the external device.

In addition, if the absolute value of the difference between the first response time and the second response time is greater than the first threshold, the response time measuring module 303 measures the response time once again. Specifically, the response time measuring module 303 measures a third response time which is indicative of an elapsed time from when a third connection request signal is transmitted to the external device by the connection request transmitter 301, to when a third connection response signal, which responds to the third connection request signal, is received by the connection response receiver 302 from the external device. Then, using the above-described second response time and the newly measured third response time, the stability determination module 304 determines the stability of communication between the close proximity wireless communication module 20 and the external device. If the response time measuring module 303 determines that the communication between the close proximity wireless communication module 20 and the external device is in the high-stability state or in the stable state, the connection establishing module 305 establishes the connection between the close proximity wireless communication module 20 and the external device. Specifically, the measurement of the response time and the determination of the stability are performed until the communication between the close proximity wireless communication module 20 and the external device is determined to be in the high-stability state or in the stable state. If the communication between the close proximity wireless communication module 20 and the external device is in the unstable state even after the measurement of the response time and the determination of the stability are performed a predetermined number of times or more, the display controller 306 displays on the screen of the LCD 17, or the like, a message prompting the user to re-operate (re-connect) the devices.

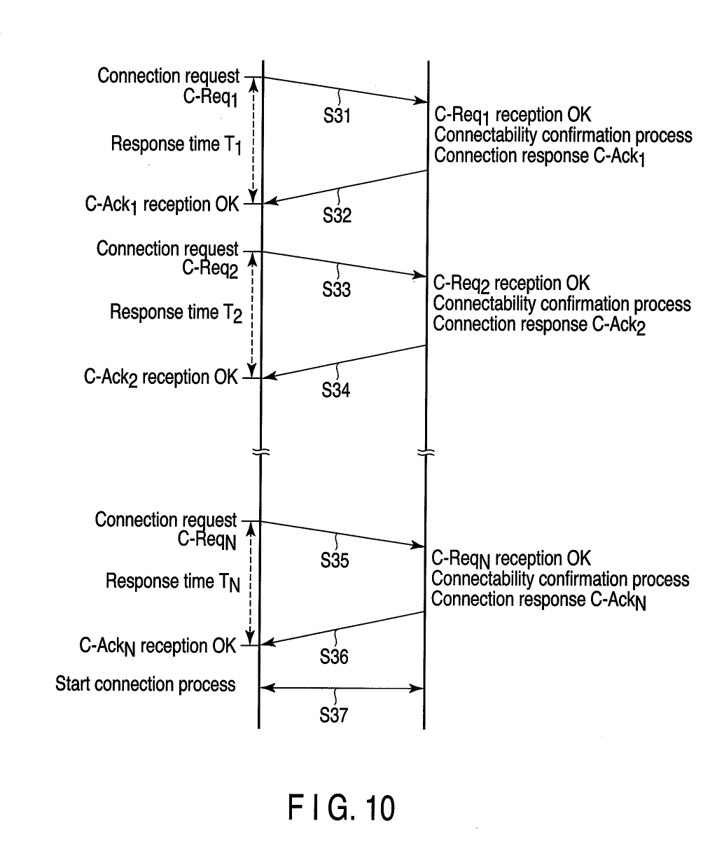

Besides, after the response time has been measured a predetermined number of times by the response time measuring module 303, the stability determination module 304 may determine the stability by using the response times which have been measured the predetermined number of times. FIG. 10 to FIG. 12 show examples of sequence in which the stability of communication between the close proximity wireless communication module 20 and the external device is determined by using response times which have been measured a predetermined number of times.

FIG. 10 shows an example in which the communication between the close proximity wireless communication module 20 and the external device is determined to be in the high-stability state, based on the response times which have been measured N times, and then the connection between the close proximity wireless communication module 20 and the external device is established. In the sequence of FIG. 10, for example, it is assumed that the distance between the close proximity wireless communication module 20 and the external device is sufficiently short, and the close-proximity state between the devices is maintained (i.e. the positional relationship between the devices does not vary).

To start with, the connection request transmitter 301 transmits a connection request signal C-Req₁ to the external device (S31). Responding to the transmission of the connection request signal C-Req₁, the response time measuring module 303 starts measuring a response time T₁.

Responding to the reception of the connection request signal C-Req₁ transmitted by the connection request transmitter 301, the external device executes a process of confirming whether the connection to the close proximity wireless communication module 20 is enabled. If the connection to the close proximity wireless communication module 20 is enabled, the external device transmits a connection response signal C-Ack₁, which is indicative of the acceptance of the connection request, to the close proximity wireless communication module 20 (S32).

Subsequently, the connection response receiver 302 receives the connection response signal C-Ack₁ transmitted from the external device. Responding to the reception of the connection response signal C-Ack₁, the response time measuring module 303 completes the measurement of the response time T₁. Specifically, the response time measuring module 303 measures, as the response time T₁, the elapsed time from when the connection request signal C-Req₁ was transmitted by the connection request transmitter 301 to when the connection response signal C-Ack₁ has been received by the connection response receiver 302.

Similarly, the response time measuring module 303 measures response times T₂ to T_{N} (S33 to S36). Based on the measured response times T₁ to T_{N}, the stability determination module 304 determines the stability of communication between the close proximity wireless communication module 20 and the external device. In the measurement of the response times T₁ to T_{N}, no delay occurs in response time due to, e.g. re-transmission of a connection request signal, and the variation in response time is small. Since the absolute value of the difference between the response times is equal to or smaller than the threshold and the average of the response times is equal to or smaller than the threshold, the stability determination module 304 determines that the stability of the communication between the close proximity wireless communication module 20 and the external device is in the high-stability state. Accordingly, the connection establishing module 305 starts the process for establishing the connection between the close proximity wireless communication module 20 and the external device (S37).

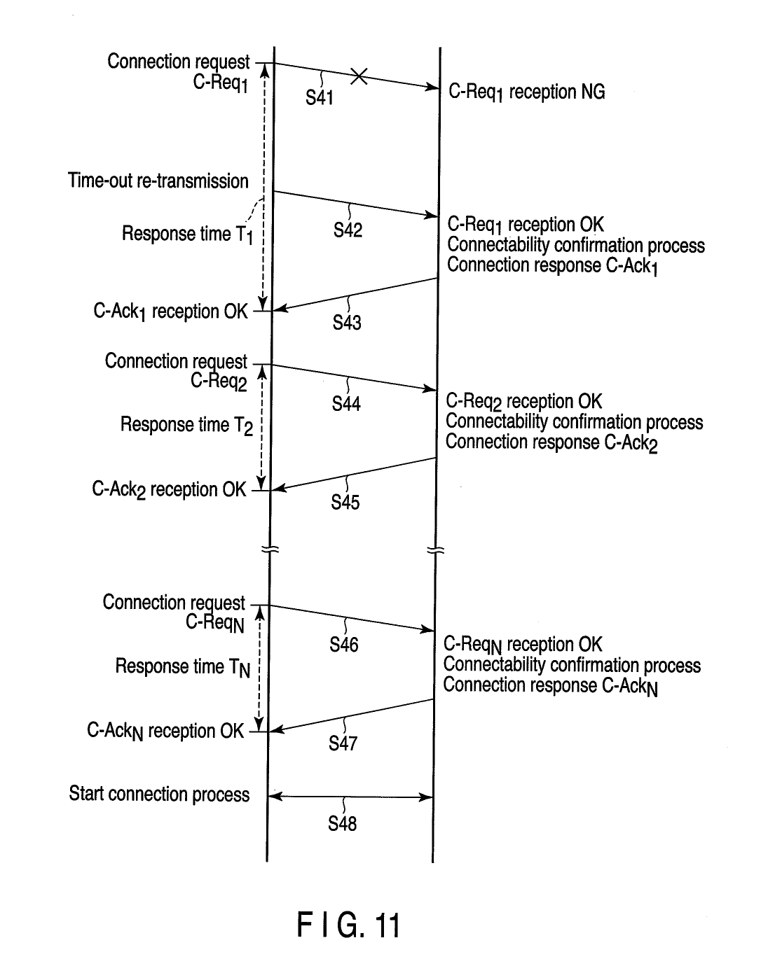

FIG. 11 shows an example in which the communication between the close proximity wireless communication module 20 and the external device is determined to be in the stable state, based on the response times which have been measured N times, and then the connection between the close proximity wireless communication module 20 and the external device is established. In the sequence of FIG. 11, for example, it is assumed that the operation of bringing the external device close to the close proximity wireless communication module 20 is performed, and thereafter the close-proximity state between the devices is maintained.

To start with, the connection request transmitter 301 transmits a connection request signal C-Req₁ to the external device (S41). Responding to the transmission of the connection request signal C-Req₁, the response time measuring module 303 starts measuring a response time T₁.

Since the connection response receiver 302 does not receive a connection response signal C-Ack₁ from the external device during a predetermined time or more, the process of receiving the connection response signal C-Ack₁ is timed out. Responding to the time-out of the process of receiving the connection response signal C-Ack₁, the connection request transmitter 301 re-transmits the connection request signal C-Req₁ to the external device (S42).

Responding to the reception of the connection request signal C-Req₁ re-transmitted by the connection request transmitter 301, the external device executes a process of confirming whether the connection to the close proximity wireless communication module 20 is enabled. If the connection to the close proximity wireless communication module 20 is enabled, the external device transmits a connection response signal C-Ack₁, which is indicative of the acceptance of the connection request, to the close proximity wireless communication module 20 (S43).

Subsequently, the connection response receiver 302 receives the connection response signal C-Ack₁ transmitted from the external device. Responding to the reception of the connection response signal C-Ack₁, the response time measuring module 303 completes the measurement of the response time T₁. Specifically, the response time measuring module 303 measures, as the response time T₁, the elapsed time from when the connection request signal C-Req₁ was transmitted by the connection request transmitter 301 to when the connection response signal C-Ack₁ has been received by the connection response receiver 302 after the re-transmission of the connection request signal C-Req₁ due to the time-out.

Similarly, the response time measuring module 303 measures response times T₂ to T_{N} (S44 to S47). In the measurement of the response times T₂ to T_{N}, no delay occurs in response time due to time-out, and the elapsed time from when the connection request signal C-Req was transmitted by the connection request transmitter 301 to when the connection response signal C-Ack has been received by the connection response receiver 302 is measured as the response time T.

Based on the measured response times T₁ to T_{N}, the stability determination module 304 determines the stability of communication between the close proximity wireless communication module 20 and the external device. In the measurement of the response time T₁, a delay occurred in response time due to the re-transmission of the connection request signal. However, in the subsequent measurement of the response times T₂ to T_{N}, no delay has occurred in response time due to, e.g. re-transmission of a connection request signal, and the variation in response time is small. Since the absolute value of the difference between the response times T₂ to T_{N} is equal to or smaller than the threshold and the average of the response times is equal to or smaller than the threshold, the stability determination module 304 determines that the stability of the communication between the close proximity wireless communication module 20 and the external device is in the stable state. Accordingly, the connection establishing module 305 starts the process for establishing the connection between the close proximity wireless communication module 20 and the external device (S48).

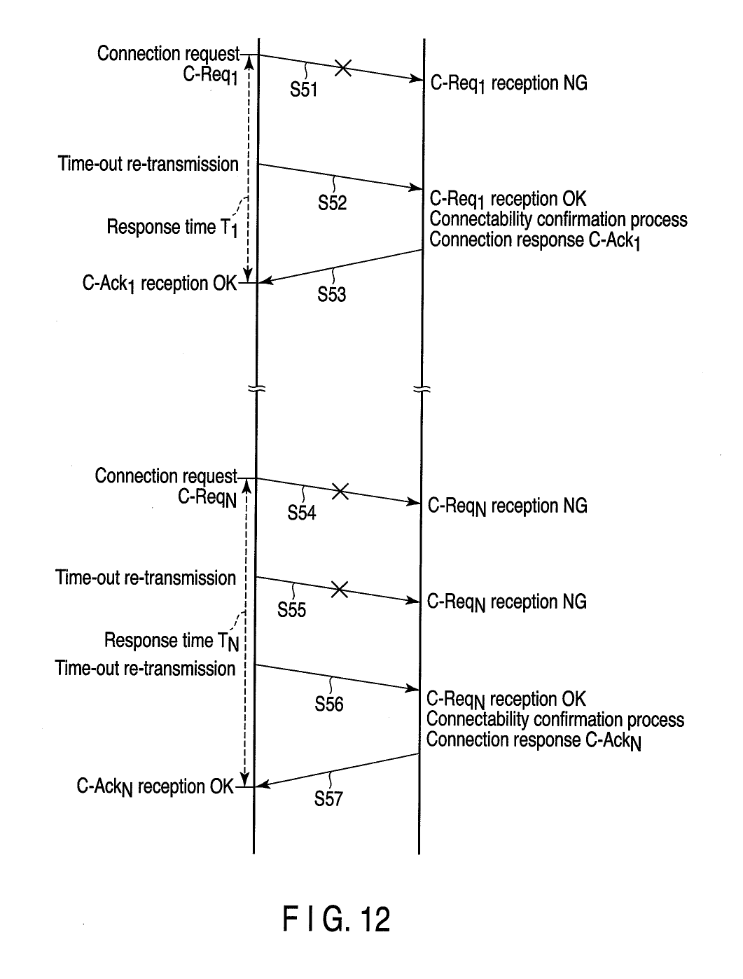

FIG. 12 shows an example in which the communication between the close proximity wireless communication module 20 and the external device is determined to be in the unstable state, based on the response times which have been measured N times, and then the connection between the close proximity wireless communication module 20 and the external device is not established. In the sequence of FIG. 12, for example, it is assumed that the operation of moving the external device away from the close proximity wireless communication module 20 is performed.

To start with, the connection request transmitter 301 transmits a connection request signal C-Req₁ to the external device (S51). Responding to the transmission of the connection request signal C-Req₁, the response time measuring module 303 starts measuring a response time T₁.

Since the connection response receiver 302 does not receive a connection response signal C-Ack₁ from the external device during a predetermined time or more, the process of receiving the connection response signal C-Ack₁ is timed out. Responding to the time-out of the process of receiving the connection response signal C-Ack₁, the connection request transmitter 301 re-transmits the connection request signal C-Req₁ to the external device (S52).

Responding to the reception of the connection request signal C-Req₁ re-transmitted by the connection request transmitter 301, the external device executes a process of confirming whether the connection to the close proximity wireless communication module 20 is enabled. If the connection to the close proximity wireless communication module 20 is enabled, the external device transmits the connection response signal C-Ack₁, which is indicative of the acceptance of the connection request, to the close proximity wireless communication module 20 (S53).

Subsequently, the connection response receiver 302 receives the connection response signal C-Ack₁ transmitted from the external device. Responding to the reception of the connection response signal C-Ack₁, the response time measuring module 303 completes the measurement of the response time T₁. Specifically, the response time measuring module 303 measures, as the response time T₁, the elapsed time from when the connection request signal C-Req₁ was transmitted by the connection request transmitter 301 to when the connection response signal C-Ack₁ has been received by the connection response receiver 302 after the re-transmission of the connection request signal C-Req₁ due to the time-out.

Similarly, the response time measuring module 303 measures response times T₂ to T_{N} (S54 to S57). In the measurement of the response times T₂ to T_{N}, like the sequences S51 to S53, a delay occurs due to time-out, and the response time measuring module 303 measures, as the response time T, the elapsed time from when the connection request signal C-Req was transmitted by the connection request transmitter 301 to when the connection response signal C-Ack has been received by the connection response receiver 302 after the re-transmission of the connection request signal C-Req due to the time-out.

Based on the measured response times T₁ to T_{N}, the stability determination module 304 determines the stability of communication between the close proximity wireless communication module 20 and the external device. In the measurement of the response times T₁ to T_{N}, a delay occurred in response time due to the re-transmission of the connection request signal and the variation in response time is large. In the response times T₁ to T_{N}, since the absolute value of the difference between the response times is greater than the threshold and the average of the response times is greater than the threshold, the stability determination module 304 determines that the stability of the communication between the close proximity wireless communication module 20 and the external device is in the unstable state. Accordingly, the connection establishing module 305 does not start the process for establishing the connection between the close proximity wireless communication module 20 and the external device.

As has been described above, using the response times measured a plural number of times, the stability determination module 304 determines the stability of the communication between the close proximity wireless communication module 20 and the external device. When stable close proximity wireless communication is executable, the connection establishing module 305 establishes the connection between the devices. By using the response times measured a plural number of times, the precision of determination of the speed of communication and the stability of communication can be enhanced.

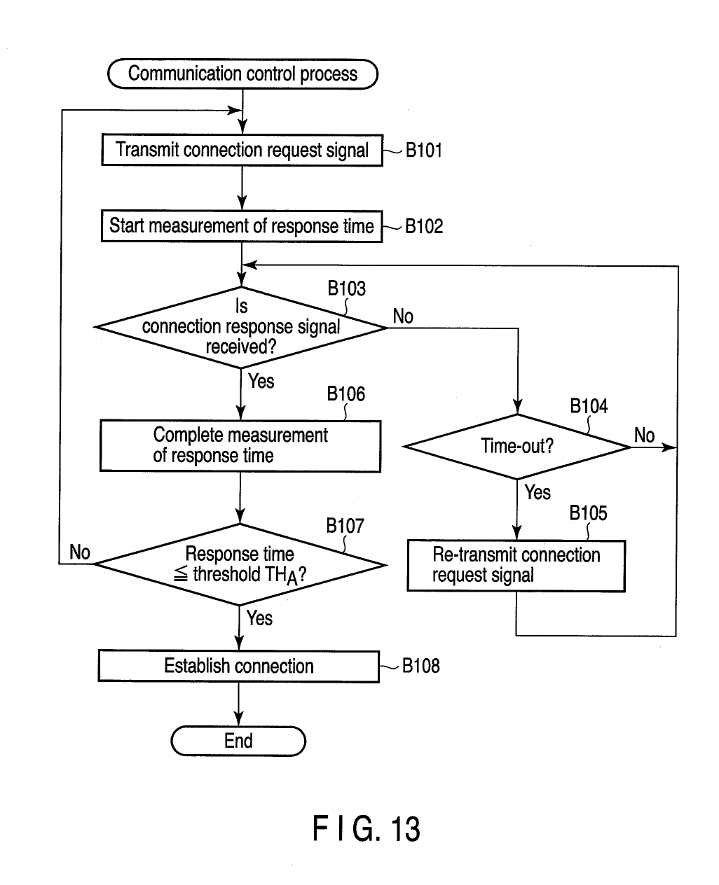

Next, referring to a flowchart of FIG. 13, a description is given of an example of the procedure of a connection control process for controlling connection between the close proximity wireless communication module 20 and the external device. In the description below, a variable i is an integer of 1 or more, which represents the number of times of measurement of a response time between the close proximity wireless communication module 20 and the external device.

To start with, the communication control program 202 transmits a connection request signal C-Reqᵢ to the external device (block B101). Responding to the transmission of the connection request signal C-Reqᵢ, the communication control program 202 starts measuring a response time Tᵢ (block B102).

Then, the communication control program 202 determines whether a connection response signal C-Ackᵢ responding to the transmitted connection request signal C-Reqᵢ has been received from the external device (block B103). If the connection response signal C-Ackᵢ has not been received from the external device (NO in block B103), the communication control program 202 determines whether or not to time out the process of receiving the connection response signal C-Ackᵢ (block B104). Specifically, the communication control program 202 determines, for example, whether a predetermined time (time-out threshold) or more has passed since the connection request signal C-Regᵢ was transmitted to the external device.

If the process of receiving the connection response signal C-Ackᵢ is timed out (YES in block B104), the communication control program 202 re-transmits the connection request signal C-Reqᵢ (block B105). Then, the communication control program 202 returns to block B103. On the other hand, if the process of receiving the connection response signal C-Ackᵢ is not timed out (NO in block B104), the communication control program 202 returns to block B103.

If the connection response signal C-Ackᵢ has been received from the external device (YES in block B103), the communication control program 202 completes the measuring of the response time Tᵢ (block B106). Then, the communication control program 202 determines whether the measured response time Tᵢ is equal to or smaller than a threshold TH_{A} (block B107). If the measured response time Tᵢ is equal to or smaller than the threshold TH_{A} (YES in block B107), the communication control program 202 establishes connection between the close proximity wireless communication module 20 and the external device (block B108). If the measured response time Tᵢ is greater than the threshold TH_{A} (NO in block B107), the communication control program 202 newly measures a response time Tᵢ₊₁, and then determines whether or not to establish the connection between the devices based on the measured response time Tᵢ₊₁ by returning to block B101. In block B107, the communication control program 202 may determine whether an average response time, which is calculated by averaging the measured response times Tᵢ to Tᵢ₊₁, is equal to or smaller than the threshold TH_{A}.

By the above-described process, if the measured response time Tᵢ is equal to or smaller than the threshold TH_{A}, that is, if it is estimated that the stability of communication between the close proximity wireless communication module 20 and the external device is high, the communication control program 202 establishes the connection between the devices. On the other hand, if the measured response time Tᵢ is greater than the threshold TH_{A}, that is, if it is estimated that the stability of communication between the close proximity wireless communication module 20 and the external device is low, the communication control program 202 does not establish the connection between the devices, and then newly measures the response time Tᵢ₊₁. That is, when stable close proximity wireless communication is executable, the communication control program 202 can establish the connection between the close proximity wireless communication module 20 and the external device.

If it is estimated that the stability of communication between the close proximity wireless communication module 20 and the external device is low even after the determination of the stability, which is based on the response time Tᵢ, has been executed a predetermined number of times or more (i.e. if the response time is greater than the threshold TH_{A}), a message prompting the user, for example, to vary the positional relationship between the devices may be displayed on the LCD 17.

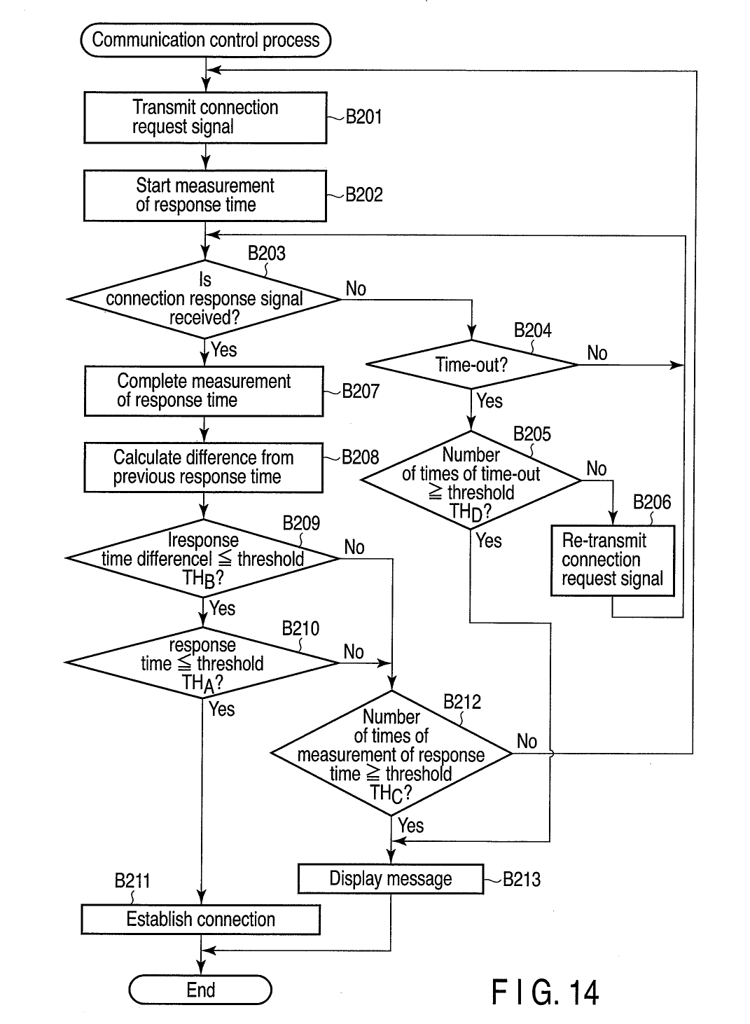

FIG. 14 shows another example of the procedure of the connection control process for controlling the connection between the close proximity wireless communication module 20 and the external device. As described above, the variable i is an integer of 1 or more, which represents the number of times of measurement of a response time Tᵢ between the close proximity wireless communication module 20 and the external device.

To start with, the communication control program 202 transmits a connection request signal C-Reqᵢ to the external device (block B201). Responding to the transmission of the connection request signal C-Reqᵢ, the communication control program 202 starts measuring a response time Tᵢ (block B202).

Then, the communication control program 202 determines whether a connection response signal C-Ackᵢ responding to the transmitted connection request signal C-Reqᵢ has been received from the external device (block B203). If the connection response signal C-Ackᵢ has not been received from the external device (NO in block B203), the communication control program 202 determines whether or not to time out the process of receiving the connection response signal C-Ackᵢ (block B204). Specifically, the communication control program 202 determines, for example, whether a predetermined time (time-out threshold) or more has passed since the connection request signal C-Reqᵢ was transmitted to the external device.

If the process of receiving the connection response signal C-Ackᵢ is timed out (YES in block B204), the communication control program 202 determines whether the number of times of time-out in block B204 since the transmission of the connection request signal C-Reqᵢ to the external device in block B201 is equal to or greater than a threshold TH_{D} (block B205). If the number of times of time-out is smaller than the threshold TH_{D} (NO in block S205), the communication control program 202 re-transmits the connection request signal C-Reqᵢ (block B206). Then, the communication control program 202 returns to block B203. On the other hand, if the process of receiving the connection response signal C-Ackᵢ is not timed out (NO in block B204), the communication control program 202 returns to block B203.

If the connection response signal C-Ackᵢ has been received from the external device (YES in block B203), the communication control program 202 completes the measurement of the response time Tᵢ (block B207). Then, the communication control program 202 calculates a difference ΔTᵢ between the measured response time Tᵢ and an immediately previously measured response time Tᵢ₋₁ (block B208). In the case of measuring a first response time T₁, the process in block B208 is skipped and the communication control program 202 measures a second response time T₂ by returning to block B201.

Then, the communication control program 202 determines whether the absolute value |ΔTᵢ| of the calculated difference between the response times is equal to or smaller than a threshold TH_{B} (block B209). If the absolute value |ΔTᵢ| of the calculated difference between the response times is equal to or smaller than the threshold TH_{B} (YES in block B209), the communication control program 202 determines whether the measured response time Tᵢ is equal to or smaller than a threshold TH_{A} (block B210). If the measured response time Tᵢ is equal to or smaller than the threshold TH_{A} (YES in block B210), the communication control program 202 establishes connection between the close proximity wireless communication module 20 and the external device (block B211).

If the measured response time Tᵢ is greater than the threshold TH_{A} (NO in block B210), the communication control program 202 determines whether the number i of times of measurement of the response time is equal to or greater than a threshold TH_{C} (block B212). If the number i of times of measurement of the response time is equal to or greater than the threshold TH_{C} (YES in block B212) or if the number of times of time-out is equal to or greater than the threshold TH_{D} (YES in block B205), the communication control program 202 causes the LCD 17 to display a message prompting the user, for example, to vary the positional relationship between the close proximity wireless communication module 20 and the external device (block B213).

If the number i of times of measurement of the response time is less than the threshold TH_{C} (NO in block B212), the communication control program 202 newly measures a response time Tᵢ₊₁, and then determines whether or not to establish the connection between the devices based on the measured response time Tᵢ₊₁ by returning to block B201. In block B210, the communication control program 202 may determine whether an average response time, which is calculated by averaging the measured response times Tᵢ to Tᵢ₊₁, is equal to or smaller than the threshold TH_{A}.

By the above-described process, if the absolute value |ΔTᵢ| of the difference between the previously measured response time Tᵢ₋₁ and the currently measured response time Tᵢ is equal to or smaller than the threshold TH_{B}, and if the currently measured response time Tᵢ is equal to or smaller than the threshold TH_{A}, that is, if it is estimated that the stability of communication between the close proximity wireless communication module 20 and the external device is high, the communication control program 202 establishes the connection between the devices. On the other hand, if the absolute value |ΔTᵢ| of the difference between the previously measured response time Tᵢ₋₁ and the currently measured response time Tᵢ is greater than the threshold TH_{B}, or if the measured response time Tᵢ is greater than the threshold TH_{A}, that is, if it is estimated that the stability of communication between the close proximity wireless communication module 20 and the external device is low, the communication control program 202 does not establish the connection between the devices, and newly measures the response time. That is, when stable close proximity wireless communication is executable, the communication control program 202 can establish the connection between the close proximity wireless communication module 20 and the external device. Furthermore, if it is estimated that the stability of communication between the close proximity wireless communication module 20 and the external device is low even after the determination of the stability, which is based on the response time, has been executed a predetermined number of times or more, a message is displayed to prompt the user to re-perform a touch operation for bringing the external device close to the close proximity wireless communication module 20 (or a touch operation for bringing the close proximity wireless communication module 20 to the external device).

The stability of communication and the speed of communication may be determined by using not only the difference of response times or the average of response times, but also various statistical information such as a weighted mean, a median, or a variance. In the present embodiment, the stability of communication is determined by using the relationship between the response time and throughput, but the stability of communication may be determined by using the relationship between the response time and an error rate. In this case, the data indicative of the relationship between the response time and error rate is stored in the stability determination table 304A.

As has been described above, according to the present embodiment, when stable close proximity wireless communication is executable, the connection between the devices can be established. The communication control program 202 measures the response time which is indicative of the elapsed time from when the connection request signal is transmitted from the close proximity wireless communication module 20 to the external device to when the close proximity wireless communication module 20 receives the connection response signal. Based on the response time, the communication control program 202 determines the stability of communication between the close proximity wireless communication module 20 and the external device. When predetermined stability is ensured, the communication control program 202 establishes the connection between the close proximity wireless communication module 20 and the external device. Thus, when stable close proximity wireless communication is executable, the connection between the devices can be established. In addition, by performing the measurement of the response time a plural number of times, the precision of determination of the stability of communication between the devices can be enhanced.

Furthermore, by displaying the index indicating the stability on the screen or the like, the user can understand the stability of communication between the devices. When the stability of communication between the devices is low, a message prompting the user to re-operate the devices is displayed, and thereby the user can recognize the need to perform an operation of varying the positional relationship between the devices.

In the present embodiment, the determination of the stability of communication and the display of the index of the stability are performed in the electronic apparatus 10 which requests connection. Alternatively, the determination of the stability of communication and the display of the index of the stability may be performed in the external device which responds to the connection request. In this case, the communication control program 202 may transmit to the external device the information necessary for the determination and display of the stability.

All the procedures of the connection control process in this embodiment may be executed by software. Thus, the same advantageous effects as with the present embodiment can easily be obtained simply by installing a computer program, which executes the procedures of the connection control process, into an ordinary computer through a computer-readable storage medium.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a communicator configured to execute a close proximity wireless communication;
a connection request transmitter configured to transmit a first connection request signal to an external device close to the communicator;
a connection response receiver configured to receive, from the external device, a first connection response signal in response to the connection request signal;
a response timer configured to measure a first response time, wherein the first response time comprises an elapsed time from the transmission of the first connection request signal to the reception of the first connection response signal;
a stability determiner configured to determine whether communication between the communicator and the external device is in a stable state based on the first response time; and
a connection controller configured to establish connection between the communicator and the external device when the stability determiner determines that the communication is in the stable state.

2. The electronic apparatus of claim 1, wherein the stability determiner is further configured to determine that the communication is in the stable state when the first response time is equal to or less than a first threshold.

3. The electronic apparatus of claim 1, wherein the connection request transmitter is further configured to transmit a second connection request signal to the external device,
the connection response receiver is further configured to receive, from the external device, a second connection response signal in response to the second connection request signal,
the response timer is further configured to measure a second response time, wherein the second response time comprises an elapsed time from the transmission of the second connection request signal to the reception of the second connection response signal, and
the stability determiner is further configured to determine that the communication between the communicator and the external device is in the stable state when the second response time is equal to or less than a first threshold and the absolute value of the difference between the first response time and the second response time is equal to or less than a second threshold.

4. The electronic apparatus of claim 1, wherein the connection request transmitter is further configured to transmit a second connection request signal to the external device,
the connection response receiver is further configured to receive, from the external device, a second connection response signal in response to the second connection request signal,
the response timer is further configured to measure a second response time, wherein the second response time comprises an elapsed time from the transmission of the second connection request signal to the reception of the second connection response signal, and
the stability determiner is further configured to determine that the communication is in the stable state when the average of the first response time and the second response time is equal to or less than a first threshold and the absolute value of the difference between the first response time and the second response time is equal to or less than a second threshold.

5. The electronic apparatus of claim 1, wherein the connection request transmitter is further configured to re-transmit the first connection request signal, as a re-transmitted connection request signal, when the first connection response signal is not received within a predetermined time, and
the connection response receiver is further configured to receive a first connection response signal in response to the re-transmitted connection request signal.

6. The electronic apparatus of claim 1, wherein the stability determiner is further configured to calculate an index indicating stability of the communication based on the response time, and
the electronic apparatus further comprises a stability display configured to display the index indicating the stability.

7. The electronic apparatus of claim 1, further comprising a message display configured to display a message prompting alignment of a positional relationship between the communicator and the external device when the stability determiner determines that the communication is not in the stable state.

8. The electronic apparatus of claim 1, wherein the connection controller is further configured to establish the connection only when the stability determiner determines that the communication is in the stable state.

9. A communication control method of controlling close proximity wireless communication executed by a communicator, comprising:
transmitting a connection request signal to an external device close to the communicator;
receiving, from the external device, a connection response signal in response to the connection request signal;
measuring a response time, wherein the response time comprises an elapsed time from the transmission of the connection request signal to the reception of the connection response signal;
determining whether communication between the communicator and the external device is in a stable state based on the response time; and
establishing a connection between the communicator and the external device when the communication is in the stable state.
